(19) United States
(12) Patent Application Publication
(10) Pub. No.: US 2004/0189690 A1
(43) Pub. Date: Sep. 30, 2004

(54) System and method for previewing digital content

(75) Inventors: Thomas Poslinski, San Diego, CA (US); Kim Annon Ryal, Poway, CA (US)

Correspondence Address: FITCH EVEN TABIN AND FLANNERY, 120 SOUTH LA SALLE STREET, SUITE 1600, CHICAGO, IL, 60603-3406, US

(73) Assignees: Sony Corporation, Tokyo (JP); Sony Electronics Inc., Park Ridge, NJ

(21) Appl. No.: 10/403,102

(22) Filed: Mar. 28, 2003

(51) Int. Cl. G09G 5/00

(52) U.S. Cl. 345/719

(57) ABSTRACT

A system and method for providing a preview of content in a content preview screen that is available for viewing. The step for providing the preview of content include receiving from a user a request to preview video content that is stored in a memory, locating the video content in the memory, retrieving a portion of the video content from the memory and displaying, prior to the user requesting to view the video content, the portion of the video content. In variations, the system provides a preview of content from a point in the content where the user previously stopped viewing the content.

### BACKGROUND OF THE INVENTION

1. Field of the Invention

The present invention relates generally to digital video players, and more specifically to control and feedback mechanisms for digital video players.

2. Discussion of the Related Art

Digital video player technology has advanced to a point where several pieces of digital content, e.g., digital video content, may be stored, indexed and accessed at a video player from one or more content storage devices, e.g., hard disc drives (HDD).

Graphical user interfaces have been incorporated into digital video players that allow a user to obtain a listing of the content available for viewing, e.g., content available on a hard drive of the video player. With the listing, the user is able to select a particular video, e.g., by title, and view textual information about the video including a written description of the video's content.

### SUMMARY OF THE INVENTION

In one embodiment, the invention can be characterized as a method, and means for accomplishing the method, of presenting content to a user, the method including the steps of: receiving a request to preview video content stored in a memory from a user, locating the video content in the memory, retrieving a portion of the video content from the memory and displaying, prior to the user requesting to view the video content, the portion of the video content.

In another embodiment, the invention can be characterized as a computer readable medium encoded with code segments for previewing video content, the computer readable medium comprising: a code segment for saving, in a memory, an identification of a location within video content where the user stopped viewing the video content; a code segment for obtaining the identification from the memory in response to a request to preview video content from a user; and a code segment for retrieving for display a portion of the video content located at the location in response to the identification being obtained.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a diagram illustrating a content preview screen in accordance with one embodiment of the present invention;

FIG. 2 is a is a block diagram illustrating functional components of a digital video player used to implement the content preview screen of FIG. 1;

FIG. 3 is a flowchart illustrating steps traversed by the digital video player of FIG. 2 to implement the content preview screen of FIG. 1 in accordance with one embodiment; and

FIG. 4 is a diagram illustrating another content preview screen in accordance with another embodiment of the present invention.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

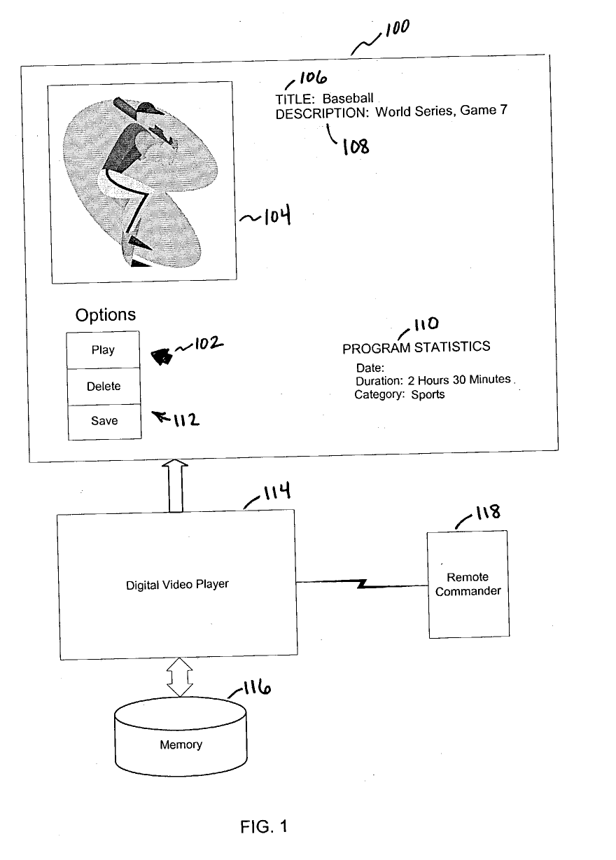

Referring first to FIG. 1, shown is a diagram illustrating a content preview screen in accordance with one embodiment of the present invention. Shown is the content preview screen 100, and within the content preview screen 100 are a cursor 102, a content display window 104, a title caption 106, a description caption 108, a program statistics caption 110 and an options menu 112 with “play”, “delete” and “save” options. Coupled with the content preview screen 100 is a digital video player 114 and coupled with the digital video player 114 is a memory component 116 and a remote commander 118.

As referred to herein, “content” generally refers to information. For example, in several embodiments, the content is video content that comprises digital information that is used to construct a video display in the content display window 104.

The content display screen 100 in several embodiments, and as shown in FIG. 1, is a graphical user interface that provides information about content available for viewing at the digital video player 114 and provides control options for the user to manipulate the available content. The content display screen 100 is presented on any type of display including television screens and computer monitors.

The digital video player 114 in several embodiments is a digital video recorder configured with software and hardware to access, record and play digital content and provide the digital content for display. In some embodiments, the digital video player 114 is a set-top box that is coupled with a cable and/or antenna feed.

The memory component 116 in several embodiments is a hard drive, but this is certainly not required. As one of ordinary skill in the art recognizes, other memory devices are available and are likely to be developed that store digital content. It should also be recognized that the memory component 116 need not be a single memory device, and instead may be, for example, a collection of memory devices.

The memory component 116 in some embodiments is within a housing of the digital video player 114, but this is certainly not required. As one of ordinary skill in the art recognizes, the memory component 116 may be locally or even remotely distributed memory elements that are networked with the digital video player 114.

In several embodiments, the cursor 102 is displayed as an arrow that is controllable by the user via the remote commander 118. The user for example, may play the content that is being previewed by directing the cursor to the “play” button in the options menu 112 and depressing a key on the remote commander 118.

As one of ordinary skill in the art recognizes, other control means may be implemented instead of the cursor 102. The buttons in the options menu 112 in other embodiments for example are highlighted in response to a user pressing keys on the remote commander 118, and when a button is highlighted the user depresses an “enter” or “select” key on the remote commander 118.

In operation, the content preview screen 104 as it is shown in FIG. 1, is displayed after a user has selected to preview a recording of a baseball game from among a listing (not shown) of potentially several other programs that are available for viewing with the digital video player 114.

As shown, after the user has requested to preview the baseball game, the digital video player 114 produces the content preview screen 100 that displays an excerpt of the content in the content display window 104. In several embodiments for example, when the user has not yet viewed any of the content that the user has selected to preview, the digital video player 114 retrieves a beginning portion of the content from the memory component 116. In one embodiment for example, the first 30 seconds of the selected content are played and repeated over and over until the user selects an option, e.g., the “play” button, on the content preview screen 100. In several embodiments, if the user has completely viewed the video, then a beginning portion of the video portion is shown as a preview.

In addition to providing a preview of previously unviewed content, the content preview screen 100 in several embodiments also provides a preview of content that is in close proximity to a point where the user previously stopped viewing the content. For example if the user has already viewed a portion of the content, in one embodiment 30 seconds of the video just following the point where the user last stopped viewing the video are repeatedly displayed for the user in the content display window 100. In these embodiments, the user is provided an option in the content preview screen 100 to resume playing the video where the user last stopped viewing the video.

Thus in several embodiments, when the user requests to preview a particular listing of content, the user is provided with information about the content that a written description alone often cannot capture: a brief glimpse at the actual content. This aspect of the present invention is beneficial because a user is able to quickly scan through several pieces of content to determine what the subject matter of each piece of content is without having to initiate and then stop play of each piece of content.

In other embodiments, the content display window 104 displays a portion of a video that begins just prior to where the user stopped viewing the video. In one embodiment, for example, the content display window 100 plays a portion of the video 15 seconds before the point where the user stopped viewing. In this way, the content preview screen 100 beneficially refreshes a user's memory about where, e.g., in a story line, the user was last viewing the video without the user having to manually rewind, stop, play, and stop again to view a portion of the video previously viewed.

In yet other embodiments, a portion of the video is pre-selected as a preview portion so that when a user requests to preview content, e.g., by positioning the cursor over a title of the content presented on the display 100, the pre-selected portion is displayed as the preview. In one embodiment, for example, 15 seconds of a well known scene in a particular movie is shown so that the user is able to quickly identify the subject matter of the movie.

In some embodiments, instead of displaying a repeating portion of the content as a preview to the user, a still image is provided. In one embodiment, for example a first frame of the portion of the content to be previewed is displayed.

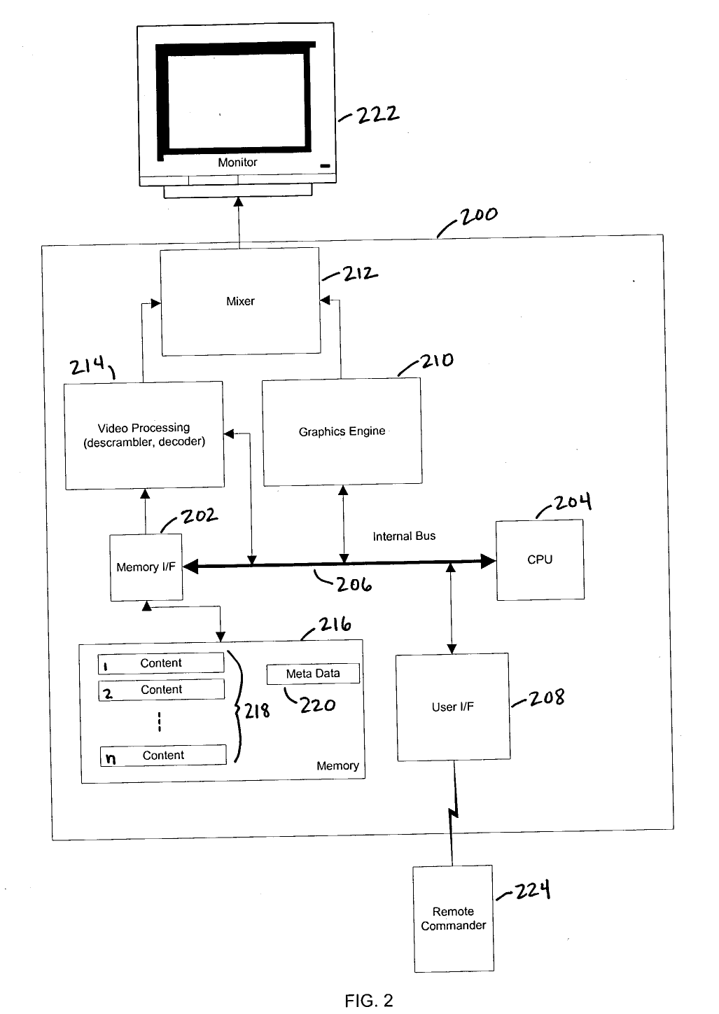

Referring to FIG. 2, shown is one embodiment of the digital video player of FIG. 1 in accordance with one embodiment of the present invention. Shown is the digital video player 200 and within the digital video player 200 are a memory interface portion 202, a central processing unit CPU 204, an internal bus 206, a user interface portion 208, a graphics engine 210, a mixer 212, a video processing portion 214 and a memory component 216. Within the memory component 216 are a first through n content blocks 218 and a meta-data block 220. Also shown are a display and a remote commander 224.

The CPU 204 is shown coupled to the memory interface module 202, the user interface portion 208, the graphics engine 210, and the video processing portion 214 via the internal bus 206, and both the video processing portion 214 and the graphics engine 210 are coupled to the mixer 212. The mixer 212 is coupled to the display 222, and the remote commander 224 is coupled to the user interface portion 208. The memory component 216 is shown coupled to the video processing portion 214.

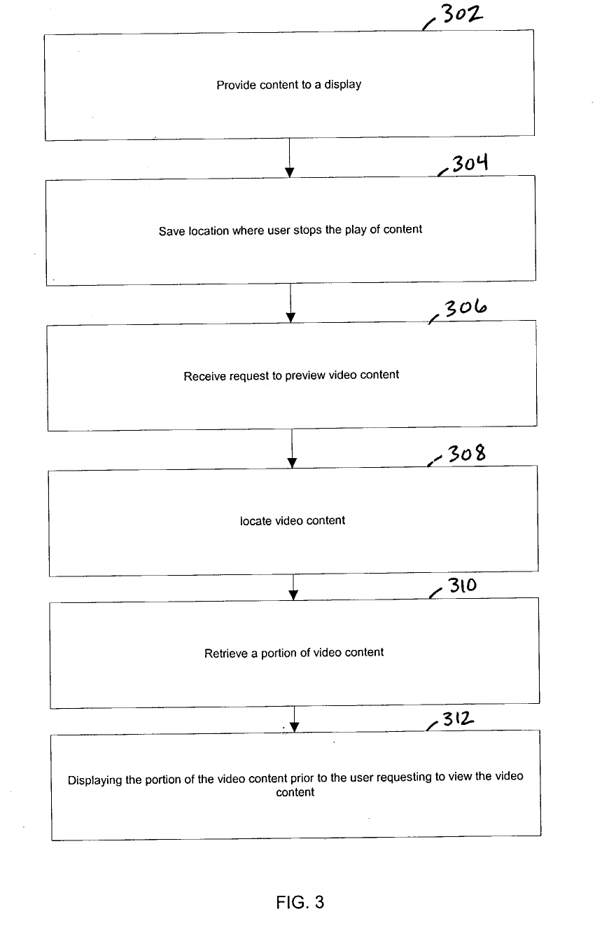

In several embodiments, the CPU 204 includes memory elements with code segments embodied therein that are interpreted and carried out by the CPU 204 to initiate steps (e.g., steps described with reference to FIG. 3) performed by the video processing portion 214, the graphics engine 210 and mixer 212. As one of ordinary skill in the art recognizes, various hardware configurations may be utilized to carry out steps of the present invention (e.g., steps described with reference to FIG. 3). Furthermore, the present invention is not limited to any particular operating system.

The video processing portion 214 represents a collection of video processing elements to access and convert the stored content from an encoded form to a decoded bit stream. In several embodiments, the video processing portion decimates the video signal to fit in a Picture in Picture (PIP) window, i.e., a smaller display window, which is shown in conjunction with the graphics user interface display.

In some embodiments, the content in the memory 216 is in a compressed state according to MPEG-2, MPEG-4 or other compression standards and the video processing portion 214 accesses the video, decompresses the video and readies the video for conversion so that it may be displayed by the display 222. In other embodiments, the video is not compressed at all, and thus, in these embodiments the video processing portion 214 does not decompress the video.

The graphics engine 210 provides graphics for the content preview screen 100 including, e.g., the content preview menu 112, the cursor 102 and the captions 106, 108, 110 shown in the content preview screen 100. As one of ordinary skill in the art recognizes, the graphics engine 210 is implemented with well known hardware and programming techniques.

To generate the content preview screen 100, the graphics provided by the graphics engine 210, e.g., the content preview menu 112, the cursor 102 and the captions 106, 108, 110, are mixed with the video signals in the mixer to generate a mixed signal.

The mixed signal then leaves the mixer and in some embodiments is converted from digital to analog in a video digital to analog converter (not shown) before being sent to the display 222. In other embodiments, the signal from the digital video player 200 to the display 222 is sent as a digital signal. In some embodiments, for example, the signal from the digital video player 200 to the display 222 is a digital signal that is transmitted according to Digital Visual Interface (DVI) specifications promulgated by the Digital Display Working Group (DDWG), which are incorporated fully herein by reference. It should be recognized, however, that the present invention is not limited to any particular encoding and/or compression protocols.

While referring to FIG. 2, simultaneous reference will be made to FIG. 3 which is a flowchart illustrating steps performed by the digital video player 200 according to one embodiment of the present invention.

In operation, when the user has requested to view one of the pieces of content in the memory 216, e.g., by selecting the content with the remote commander 224, the CPU 204 directs the video processing portion 214 to access, retrieve and decode the content to provide the content to the display 222 (Step 302 of FIG. 3).

When the user stops the play of the video, the location in the video where the user stopped the play of the video is saved (Step 304 of FIG. 3). In several embodiments, an identification of the location in the video where the user stopped viewing the content is saved in the meta-data portion 220 of the memory 216 as a quantity of data in the video from a preview reference point, e.g., a beginning of the video. The quantity of data may be represented in a variety of ways, including without limitation, as a number of bits, bytes, packets or frames.

When the digital video player 200 receives a request from the user to preview the content (Step 306 of FIG. 3), the position in the video content where the user last stopped viewing the content is located (Step 308 of FIG. 3). In the embodiments where the location in the video where the user stopped viewing the content is saved in the meta-data portion 220 of the memory 216, the meta-data portion 220 of the memory 216 is referenced to obtain the quantity of data in the video from the preview reference point, e.g., the beginning of the video.

Once the location where the user stopped viewing the content is located, the video processing portion 214 retrieves a portion of the video content (Step 310 of FIG. 3), and displays the portion of the video content prior to the user requesting to play the video content (Step 312 of FIG. 3).

In some embodiments, the portion of the video content that is retrieved and displayed is about 30 seconds of the video content, but this is certainly not required, and other lengths that provide a preview of the video may also be used.

In some of the embodiments where the content is encoded according to MPEG-2 standards, the location where the user stopped viewing the content is located and then a portion of the content beginning with a first full I frame is retrieved from the point where the user stopped viewing the content. In yet other embodiments where content is compressed, a first key frame is found before the content is decoded. This is certainly not required, however, and in other embodiments, e.g., when video is uncompressed, the first frame received is used to start viewing the video.

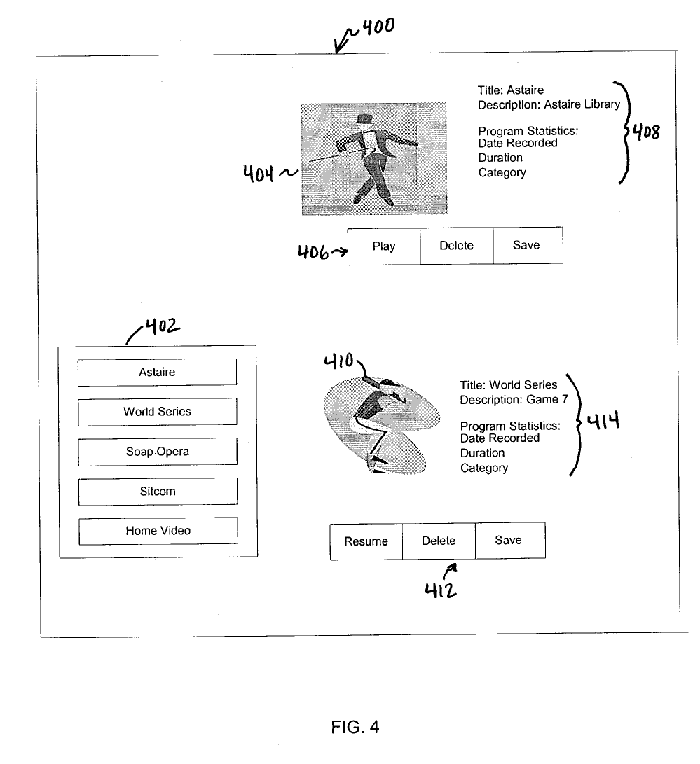

Referring next to FIG. 4, shown is a diagram illustrating another content preview screen 400 in accordance with another embodiment of the present invention. Shown are a content selection menu 402, a first content display window 404, a first options menu 406 and a first set of captions 408 describing information about the content displayed in the first content display window 404. Also shown are a second content display window 410, a second options menu 412 and a second set of captions 414 describing the content shown in the second content display window 410.

As shown in FIG. 4, in several embodiments more than one content display window is present in the content preview screen 400; thus a user is able to simultaneously preview two or more pieces of content at a time. Although two content display windows are shown, one of ordinary skill in the art recognizes that additional content display windows may be displayed depending upon the capabilities of the particular digital video player and the resolution of the display the content preview screen is presented on.

The content selection menu 402 provides a listing of content that is available for viewing at the digital video player. In one embodiment, the content selection menu 402 is a listing of content available in a memory inside a digital video player, e.g., the memory 216, but the listing may also extend to content available for play that is located in memories networked with the digital video player.

In operation, for each piece of content in the content selection menu that a user selects, a portion of the content is displayed in one of the content display windows 404, 410. For example, the content preview screen shown in FIG. 4 shows a state of the content preview screen after a user has both selected the content labeled “Astaire”, and the content labeled “World Series”.

As shown, the first content display screen 404 is showing a portion of an “Astaire” video that has not previously been viewed by the viewer. Thus, the portion of the “Astaire” video presented is a beginning portion, and the user is provided with a “Play” option rather than a “restore” option in the first options menu.

The second content display screen 410 is presenting a portion of a “World Series” video beginning from a point where the user previously stopped viewing the video, and thus, a “resume” option is provided in the second options menu 412 that allows the user to resume the play of the video at the point where the user previously stopped viewing the “world Series” video.

It should be recognized that the content preview screen 400 in FIG. 4 is exemplary only and that other configurations may be implemented without departing from the scope of the present invention. For example, there may be more options provided in the first and second options menus 406, 412 that are present along with each of the content display windows 404, 410, and the first and second options menus 406, 412 may be oriented in a variety of configurations.

It should also be recognized that other aspects of the invention disclosed herein have been described by means of specific embodiments and applications thereof, but numerous modifications and variations could be made thereto by those skilled in the art without departing from the scope of the invention set forth in the claims.

What is claimed is:

1. A method for presenting content to a user comprising the steps of:
receiving a request to preview video content from a user, wherein the video content is stored in a memory;
locating the video content in the memory;
retrieving a portion of the video content from the memory; and
displaying, prior to the user requesting to view the video content, the portion of the video content.

2. The method of claim 1, wherein the step of retrieving the portion comprises retrieving the portion of the video content from a point in the video content where the user stopped viewing the video content.

3. The method of claim 2 further comprising:
displaying a resume option in close proximity to the displayed portion of the video content thereby associating the resume option with the displayed portion of the video content; and
displaying, in response to the user selecting the resume option, the video content viewed full screen from a point in the video content that is in close proximity to where the user stopped viewing the video content.

4. The method of claim 1, wherein the step of retrieving the portion comprises retrieving the portion of the video content from just prior to a point in the video content where the user stopped viewing the particular video content.

5. The method of claim 1, further comprising:
saving, in the memory, an identification of a location within the video content where the user stopped viewing the video content;
wherein the step of locating the video content comprises retrieving the identification of the location within the video content where the user stopped viewing the video content.

6. The method of claim 5, wherein the step of saving comprises saving the identification as a quantity of data between a preview reference point of the video content and the location within the video content where the user stopped viewing the video content.

7. The method of claim 6, wherein the preview reference point of the video content is a beginning of the particular video content.

8. The method of claim 1, further comprising:
receiving a second request to preview other video content from the user, wherein the other video content is stored in the memory
locating the other video content in the memory;
retrieving a portion of the other video content from the memory; and
displaying, prior to the user requesting to view the other video content, the portion of the other video content simultaneously with the portion of the video content.

9. The method of claim 1, wherein the step of receiving a request to preview video content from a user comprises receiving a request from the user to position a cursor in close proximity to a graphical identifier of the video content.

10. An apparatus for displaying content comprising:
means for receiving a request to preview video content from a user, wherein the video content is stored in a memory;
means for locating the video content in the memory;
means for retrieving a portion of the video content from the memory; and
means for displaying, prior to the user requesting to view the video content, the portion of the video content.

11. The apparatus of claim 10, further comprising:
a housing;
wherein the memory, the means for receiving, the means for locating, the means for retrieving and the means for displaying are within the housing.

12. The apparatus of claim 11 wherein the memory comprises a hard disk drive.

13. The apparatus of claim 10 wherein the means for retrieving the portion comprises means for retrieving the portion of the video content from a point in the video content where the user stopped viewing the video content.

14. The apparatus of claim 12 further comprising:
means for displaying a resume option in close proximity to the displayed portion of the video content thereby associating the resume option with the displayed portion of the video content; and
means for displaying, in response to the user selecting the resume option, the video content from the point in the video content where the user stopped viewing the video content.

15. The apparatus of claim 10, wherein the means for retrieving the portion comprises means for retrieving the portion of the video content from just prior to a point in the video content where the user stopped viewing the particular video content.

16. The apparatus of claim 10, further comprising:
means for saving, in the memory, an identification of a location within the video content where the user stopped viewing the video content;
wherein the means for locating the video content comprises means for retrieving the identification of the location within the video content where the user stopped viewing the video content.

17. The apparatus of claim 16, wherein the means for saving comprises means for saving the identification as a quantity of data between a preview reference point of the video content and the location within the video content where the user stopped viewing the video content.

18. The apparatus of claim 17, wherein the preview reference point of the video content is a beginning of the particular video content.

19. The apparatus of claim 10, further comprising:
means for receiving a second request to preview other video content from the user, wherein the other video content is stored in the memory
means for locating the other video content in the memory;
means for retrieving a portion of the other video content from the memory; and
means for displaying, prior to the user requesting to view the other video content, the portion of the other video content simultaneously with the portion of the video content.

20. A computer readable medium encoded with code segments for previewing video content, the computer readable medium comprising:
a code segment for saving, in a memory, an identification of a location within video content where the user stopped viewing the video content;
a code segment for obtaining the identification from the memory in response to a request to preview video content from a user; and
a code segment for retrieving for display a portion of the video content located at the location in response to the identification being obtained.
